(19) United States
(12) Patent Application Publication
(10) Pub. No.: US 2018/0156539 A1
(43) Pub. Date: Jun. 7, 2018

(54) DRYING OVEN FOR CROSSLINKING A CONTINUOUS MAT OF MINERAL OR PLANT FIBERS

(71) Applicant: SAINT-GOBAIN ISOVER, Courbevoie (FR)

(72) Inventors: Bernard BAUDOUIN, Saint Paul (FR); Christine NGUYEN, Paris (FR)

(73) Assignee: SAINT-GOBAIN ISOVER, Courbevoie (FR)

(21) Appl. No.: 15/736,870

(22) PCT Filed: Jun. 17, 2016
(86) PCT No.: PCT/FR2016/051477

§ 371 Date: Dec. 15, 2017

(30) Foreign Application Priority Data
Jun. 19, 2015 (FR) 1555612

(51) Int. Cl. F26B 13/10; F26B 23/00; F26B 25/00; F26B 3/06; F27B 9/30; F27D 17/00; C03B 37/04; D04H 1/4218; C03C 25/26; C03C 25/64

(52) U.S. Cl. CPC F26B 13/103; F26B 23/002; F26B 25/004; F26B 3/06; F27B 9/3011; C03C 2218/32; C03B 37/04; D04H 1/4218; C03C 25/26; C03C 25/64; C03C 2218/112; F27D 17/004

(57) ABSTRACT

A drying oven for crosslinking a continuous mat of mineral or plant fibers includes a plurality of heating boxes through which the mat of fibers successively passes. At least one of the boxes includes, between an external insulating jacket of the drying oven and a central compartment of the box, an in-built hot-gas heating and recirculation device that includes at least one radial turbine mounted horizontally, the axis of rotation of which is arranged vertically, the turbine drawing hot gas along the axis through a gas outlet orifice of the central compartment after it has passed through the mat, and discharging it radially toward a recirculation device that recirculates the hot gas leaving the radial turbine to a gas inlet orifice of the compartment, and at least one heating device for heating the gas circulating in the box.

The invention relates to the field of drying ovens for crosslinking a continuous mat of mineral or plant fibers, particularly mineral wool, of the glass wool or rockwool type. These mats are intended to be cut to later form, for example, panels or rolls of thermal and/or acoustic insulation.

The manufacture of such mats of insulating fibers primarily involves fiberizing and depositing fibers on a perforated mobile conveyor or transporter. The newly-formed mass of fibers is pressed against the conveyer using suction boxes arranged under the transporter on which they are placed. During the fiberizing, a binder is sprayed in solution or suspension in a volatile liquid such as water onto the stretched-out fibers, this binder having adhesive properties and usually containing a heat-curable material such as a thermosetting resin.

The primary layer of relatively loose fibers on the collecting conveyor is then transferred to a heating device commonly known in the relevant field as a crosslinking drying oven. The continuous mat of fibers passes through the drying oven over the entire length thereof, thanks to conveyors facing one another above and below, pressing the mat between them and the separation of which is adjustable. Such a mat therefore exhibits a density that varies according to the amount of compression applied by the two conveyors in the drying oven.

As it passes through the drying oven, the mat is simultaneously dried and subjected to a specific heat treatment that causes the thermosetting resin in the binder present at the surface of the fibers to polymerize (“cure”, “set” or “harden”).

The procedure used to cause the binder to cure is to pass heated air through the entire thickness of the mat such that the binder present throughout the thickness of the mat is itself progressively raised to a temperature above its curing temperature. For this purpose, the crosslinking drying oven is made up of an enclosed space constituting a closed chamber in which there are a series of boxes supplied by burners with hot air circulated by blowers. Each box thus defines an independent heating zone in which specific heating conditions are set. The boxes are separated by walls having openings for the mat and the upper and lower conveyors. The use of a plurality of boxes advantageously allows a graduated and better controlled increase in the temperature of the mat as it passes through the drying oven and prevents the appearance of hot spots caused by locally excessive heating, or alternatively the presence within the mat of zones in which the binder has not been fully polymerized. A drying oven used in the method of manufacturing mineral wool thus very often comprises a multitude of boxes (for example between 2 and 10) and known means for establishing variable and independent thermal conditions within each box.

At the present time, the drying ovens used do, however, consume a great deal of energy. It is an object of the present invention to reduce the energy consumption of such drying ovens.

To this end, one subject of the invention is a drying oven for crosslinking a continuous mat of mineral or plant fibers, comprising:
a plurality of heating boxes through which said mat of fibers successively passes, said boxes each comprising a central compartment delimited by lateral, an upper and a lower walls, said compartment comprising inlet and outlet orifices for a scream of hot gas, which orifices are situated on each side of the mat of fibers, so that after the scream of hot gas has passed through the mat the binder is progressively raised to a temperature above its curing temperature,
at least one conveyor for conveying the mat through the various boxes, said conveyor being permeable to the stream of hot gas passing through said mat,
an external insulating jacket surrounding said plurality of boxes,
   said drying oven being characterized in that at least one of said boxes further comprises, between the external insulating jacket and said central compartment, an in-built hot-gas heating and recirculation device comprising:
   at least one radial turbine mounted horizontally on the upper wall or the lower wall of the central compartment, the axis of rotation of which is arranged vertically, said turbine drawing the hot gas along said axis through a gas outlet orifice of the central compartment after it has passed through the mat, and discharging it radially toward recirculation means,
   recirculation means recirculating the hot gas leaving the radial turbine to the gas inlet orifice of the compartment, said recirculation means being arranged at least in part on at least one lateral wall of the compartment,
   at least one hearing means for heating the gas circulating in said box.

Such a drying oven makes it possible to have a compact device that combines heating, blowing and supply ducts which are reduced to the strict minimum, thus minimizing pressure drops and improving the efficiency of the blowing. Such a configuration in particular makes it possible to achieve an appreciable saving on the energy needed to manufacture the mineral wool.

What is more, thanks to its compactness, the device can be included inside the jacket of insulating material provided around the box, so as to minimize heat losses in the ducts and so as to heat the ducts by radiation from the box.

According to particular embodiments, the drying oven includes one or more of the following features considered in isolation or in any technically feasible combinations;
the outlet orifice or orifices for the stream of hot gas are made in the upper wall of the central compartment and the turbine or turbines are mounted on the upper wall of the central compartment, the inlet of a turbine being positioned facing a hot-gas outlet orifice.
the outlet orifice or orifices for the stream of hot gas are made in the lower wall of the central compartment and the turbine or turbines are mounted on the lower wall of the central compartment, the inlet of a turbine being arranged facing a hot-gas outlet orifice.
the heating means is inbuilt into or opens into said box.
the gas heating means is positioned in the central compartment between the mat of fibers and the hot-gas outlet orifice.
the gas-heating means is in the form of a radiant tube.
the gas-heating means is positioned at the outlet of the radial turbine, said heating means opening into or being situated in said recirculation means.
the recirculation means comprise distribution means in gaseous communication with the outlet of the turbine, and designed to distribute the stream of removed gas over at lease part of the length of the central compartment, said distribution means being hermetically extended by at least one lateral blowing duct situated along a lateral wall of the central compartment, said blowing duct opening onto an inlet orifice of the central compartment.
the recirculation means comprise a divergent in gaseous communication with the outlet of the turbine, and hermetically extended by at least one lateral blowing duct situated along a lateral wall of the central compartment, said blowing duct opening onto an inlet orifice of the central compartment.
an extraction duct, preferably convergent, vertically connects the gas outlet orifice to a turbine inlet.
the heating and recirculation device comprises a single radial turbine arranged at the center of the upper wall or of the lower wall of the central compartment and facing a single hot-gas outlet orifice.
the heating and recirculation device comprises two radial turbines, preferably arranged with central symmetry with respect to the upper wall or the lower wall of the central compartment.
the heating and recirculation device comprises two radial turbines and each turbine is connected to separate recirculation means namely:
   a first blowing duct in fluidic communication with a first radial turbine, said blowing duct being situated on a first lateral wall of the compartment and opening onto a first inlet orifice made on said first lateral wall,
   a second blowing duct in fluidic communication with the second radial turbine, said blowing duct being situated on the opposite lateral wall of the compartment and opening onto a first inlet orifice made in said opposite lateral wall.
according to a preferred configuration of such an embodiment:
   the first inlet orifice, onto which the first blowing duct opens, has a length substantially equal to half that of the central compartment,
   the second inlet orifice, onto which the second blowing duct opens, has a length substantially equal to half that of the central compartment,
   the two orifices together cover substantially all of the length of the central compartment,
   the two orifices are in offset positions on the opposite lateral walls.
   according to certain configurations, the first inlet orifice has a length of between 0.4 and 0.6 times the length of the central compartment, the second inlet orifice has a length of between 0.4 and 0.6 times the length of the central compartment, the two orifices together cover at least 0.8 times the length of the central compartment and the two orifices are in an offset position on the opposite lateral walls,
a hot-gas bypass opening is formed between the central compartment and at least one blowing duct.

Another subject of the invention is a box as described hereinabove and in particular comprising:
a central compartment delimited by lateral, an upper and a lower walls,
inlet and outlet locks sized for the passage of a mat of fibers, comprising, in the central compartment, inlet and outlet orifices for a stream of hot gas, these being situated on each side of the mat of fibers, said box further comprising an in-built hot-gas heating and recirculation device comprising:
   at least one radial turbine mounted horizontally on the upper wall or the lower wall of the central compartment, the axis of rotation of which is arranged vertically, said turbine drawing the hot gas along said axis through a gas outlet orifice of the central compartment and discharging it radially toward recirculation means,
   recirculation means recirculating the gas leaving the radial turbine to the gas inlet orifice of the compartment, said recirculation means being arranged at least in part on at least one lateral wall of the compartment,
   at least one heating means for heating the air circulating in said box.

A final subject of the invention is a production line comprising a drying oven as described hereinabove. This is in particular a production line for the manufacture of a continuous mat of mineral and/or plant fibers, comprising at least one fiberizing unit for producing a continuous mat of mineral and/or plant fibers, a conveyor for conveying the mat and a drying oven as described hereinabove.

Such a production line may further comprise means for shaping the mat into panels and/or into rolls.

The invention will be better understood from reading the description which will follow, given solely by way of example made with reference to the attached drawings in which:

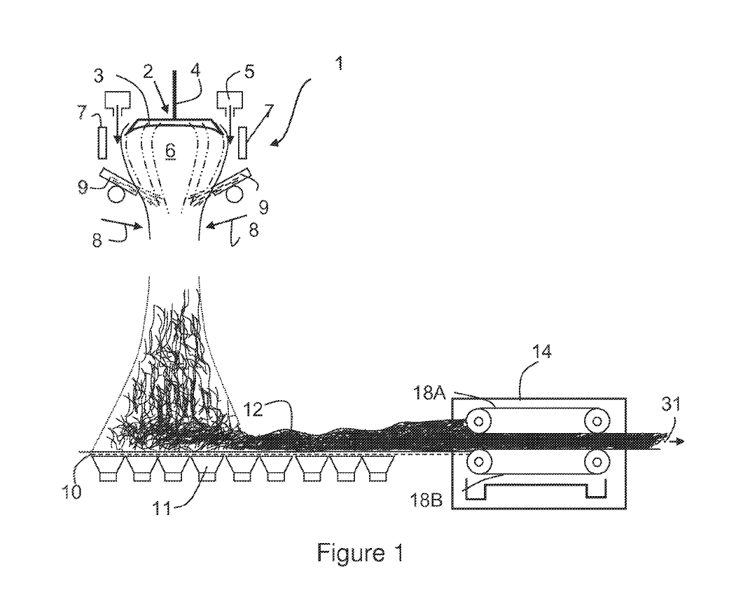

FIG. 1 describes a current installation for fiberizing a mat of mineral wool, incorporating a crosslinking drying oven;

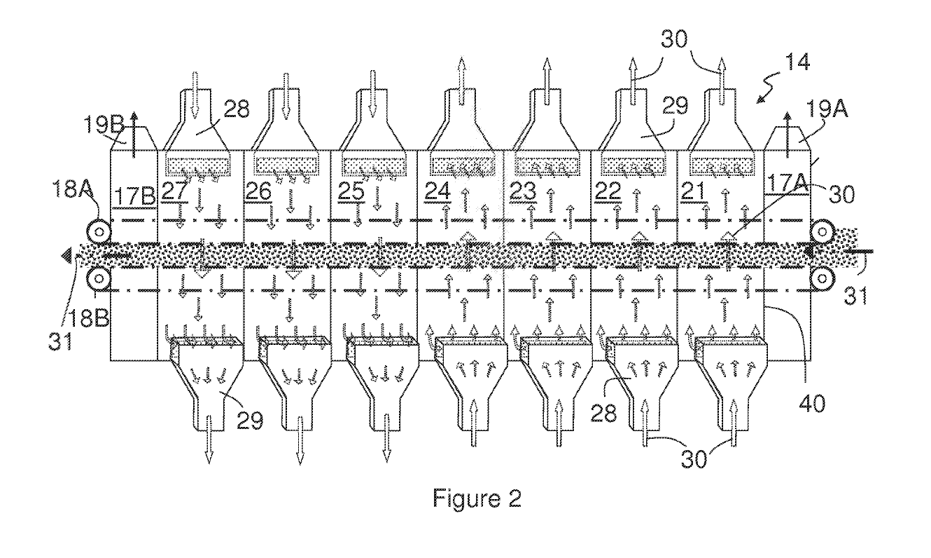

FIG. 2 is a schematic view in cross section and in greater detail of a current crosslinking drying oven comprising a plurality of independent heating boxes;

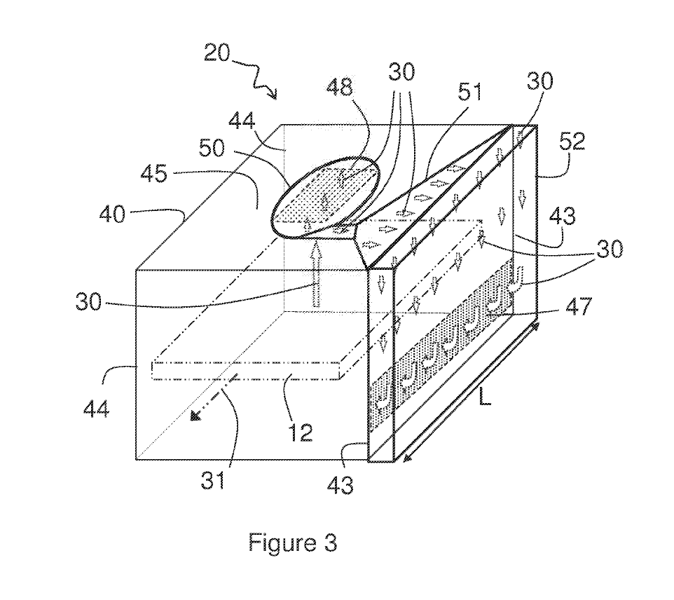

FIG. 3 is a schematic perspective view of a heating box according to the present invention and comprising a single radial turbine;

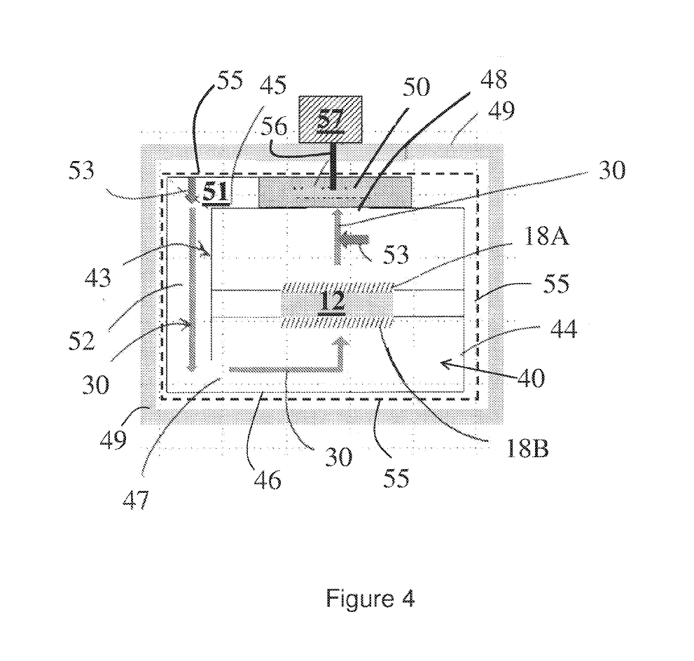

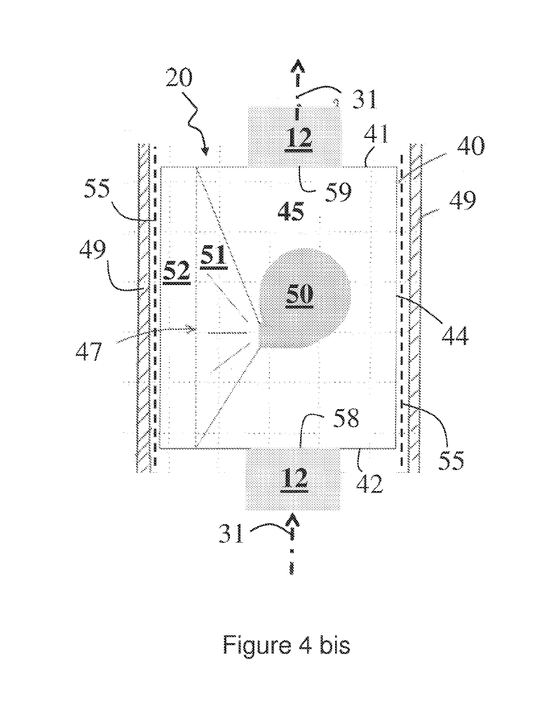

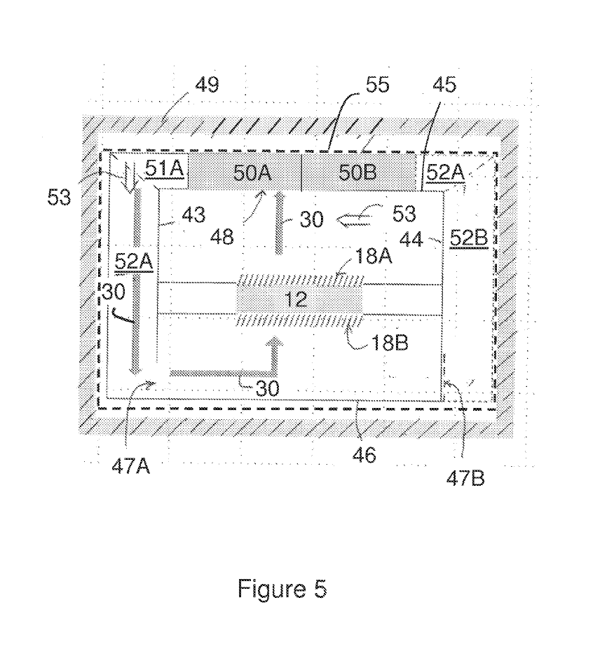

FIGS. 4 and 4bis schematically illustrate the operation of the box according to FIG. 3 within a drying oven according to the invention; and

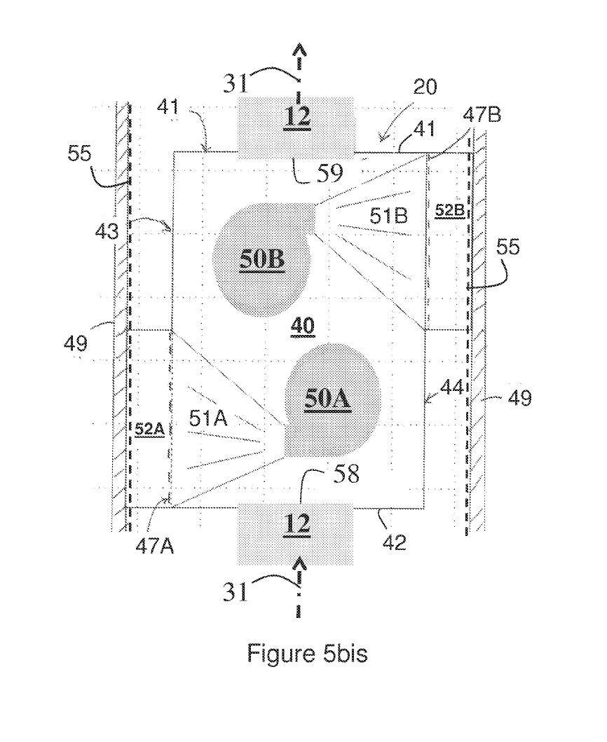

FIGS. 5 and 5bis illustrate a second example of another box according to the invention, this time comprising two radial turbines within a drying oven according to the invention.

Throughout these figures, the same numbering denotes elements that are identical or that perform the same function within the drying oven.

FIG. 1 depicts the first steps of a production line for manufacturing a continuous mat of mineral fibers, more particularly based on glass wool, it being understood that the line is of any type suited to the production of products based on mineral and possibly plant fibers.

By way of example in the case of glass wool, the line comprises a fiberizing unit 1, for example using the method of fiberizing by internal spinning. The fiberizing unit comprises a hood (not depicted in FIG. 1), surmounted by at least one spinner 2. Each spinner comprises a basket (not depicted in FIG. 1) to collect a thread of previously melted fiberizing glass and a dish-shaped component 3 the peripheral wall of which is provided with a great many orifices. During operation, the molten glass, brought in a thread 4 from a melting furnace (not depicted) and first of all collected in the spinner basket, escapes via the orifices in the dish 3 in the form of a multitude of filaments driven in rotation. The spinner 2 is also surrounded by an annular burner 5 which creates, at the periphery of the wall of the spinner, a high-speed stream of gas at a temperature high enough to draw out the glass filaments into fibers in the form of a veil 6.

Heating means 7, for example of the induction type, are used to keep the glass and spinner at the correct temperature. The veil 6 is enclosed by a gaseous stream of air introduced under pressure, indicated schematically by the arrows 8. The torus 6 thus created is surrounded by a device that sprays the binding containing a thermosetting binder in aqueous solution, only two elements 9 of which have been depicted in FIG. 1.

This may for example be a phenolic binder or an alternative binder with a low formaldehyde content, preferably even containing no formaldehyde, which binders are sometimes termed “green binders” in particular since they are at least partially derived from a renewable, particularly plant-based, raw material base, in particular based on hydrogenated or non-hydrogenated sugars.

The end of the fiberizing hood is made up of a fiber receiving device comprising a conveyor incorporating an endless belt 10 which is permeable to gases and to water, under which are positioned suction boxes 11 for gases such as air, fumes and excess aqueous compositions derived from the fiberizing process described hereinabove. A mat 12 of glass wool fibers intimately mixed with the binding compound is thus formed on the belt 10 of the conveyor. The mat 12 is conveyed by the conveyor 10 into a drying oven 14 where the thermosetting binder is crosslinked.

As depicted in FIG. 2, this drying oven 14 comprises a series of boxes separated from one another by insulated walls.

The enclosed space normally has two conveyors 18A, 18B passing through it to transport and size the mat 12. These conveyors are, for example, set in rotation by motors placed on the floor (and not depicted in FIG. 1) and are made up in the way well known per se of a series of mesh trays articulated to one another and perforated so as to be permeable to the gases.

While allowing the passage of the hot gases that encourage the binder to set quickly, the conveyors 18 usually compress the mat 12 in order to give it the desired thickness. By way of example, for a rolled up panel, this thickness is typically between 10 and 450 mm, the density of the layer of glass wool being, for example, between 5 and 150 kg/m³. A distinction can thus be made for example between products referred to as low-density products, for which the mass per unit volume varies between 5 and 20 kg/m³ and products referred to as high-density products, in which the density varies between 20 and 150 kg/m³.

FIG. 2 describes in greater detail the structure of a known drying oven 12 for crosslinking. The drying oven depicted in FIG. 2, without that being considered as limiting the scope of the present invention, comprises seven independent boxes 21-27.

The mineral wool mat sprayed with binder first of all enters an inlet lock 17A, provided with a fume extraction hood 19A, these hoods being connected to a dedicated circuit for the treatment of said fumes (which is not depicted in the figures). In this first inlet lock 17A, the hot air introduced into the mat first of all allows the residual water present in the mat of fibers to vaporize.

In the first boxes, for example boxes 21-24, the hot air is introduced from the bottom of the drying oven and removed from the top, after having passed through the mat. In the following boxes, for example boxes 25-27, the hot air is introduced this time from the top of the drying oven and removed from the bottom.

In all the figures, the circulation of air through the drying oven is indicated by arrows 30. The direction in which the mat circulates is indicated by the arrows 31. Of course, each box has an inlet and outlet opening or lock which is dimensioned to allow the passage of the mat of fibers.

The use of a plurality of boxes allows the temperature of the mat of fibers to be increased progressively up to a temperature higher than the curing temperature of the binder present on the fibers of the mat. The mechanical properties of the end-product are dependent on perfect control of the temperature in the various boxes, in particular if a green binder is used, as indicated above.

The additional fumes generated in the boxes are generally removed in an outlet lock 17B, via a hood 19B.

Each box 21-27 comprises a central compartment 40 surrounded by an insulating material, generally made of glass wool, the central compartment being surrounded by an external metal enclosed space. This then delimits an external insulating jacket for the drying oven surrounding the plurality of boxes (which is not depicted in FIG. 2). The enclosed space for each box delimits a central compartment 40. For each box, the hot air is introduced via an inlet and outlet hood system (28, 29) arranged above and below the enclosed space. In such a conventional system, the hot-air generation system (burner, blower, hood) is situated outside the external insulating jacket of the drying oven, and this not only maximizes the bulk of the installation overall but also gives rise to very great energy losses.

Although not depicted in FIG. 2, a drying oven usually comprises an external insulating jacket surrounding the collection of boxes of the drying oven, and made of an insulating material such as mineral wool. Usually, this external insulating jacket itself surrounds a first metal enclosed space which seals the installation as a whole, so that the polluted gases can be removed to the outside of the device only via the hoods 19B and 19A.

As indicated previously, the object of the present invention is to reduce the energy consumption of present-day drying ovens.

To this end, one subject of the invention is a drying oven as will now be described in relation to FIGS. 3 to 5, without of course said invention being restricted to these embodiments alone.

In a drying oven according to the invention, use is made of a compact device combining heating, blowing and supply ducts reduced to the strict minimum, thus minimizing pressure drops while at the same time improving the efficiency of the blowing.

In particular, in order to achieve such a result and according to one essential feature of the present invention, the present drying oven comprises at least one box which incorporates a specific device for generating and circulating the stream of hot gas that allows the progressive curing of the binder. For preference, all of the boxes of a drying oven according to the invention are constructed in this way.

The principles of operation and certain structural features of a drying oven/of a box according to the invention are described in greater detail and nonlimitingly hereinafter, with the aid of FIGS. 3, 4, 4bis, 5 and 5bis.

FIG. 3 depicts a box 20 according to a first embodiment of the invention schematically, in elevation, and in greater detail.

Orifices or openings 47 and 48 are made on each side of the central compartment 40 of the box, as visible in FIG. 3. The orifice 48 allows hot gas to be introduced into the compartment 40 to crosslink the binder and the orifice 48 allows the hot gas to leave after it has passed through the mat of fibers.

A radial turbine 50 is situated on the upper wall 45 of the central compartment 40, facing the hot-gas outlet orifice 48, such that its axis of rotation is situated substantially vertically. The housing of the turbine 50 may be either fixed directly to the wall 45 or alternatively connected to the outlet orifice 48 via an extraction duct (which is not depicted in FIG. 3).

This turbine is thus positioned on the compartment 40 in such a way that it draws gas through the gas outlet orifice 48 after it has passed through the mat 12. The gas (in theory air initially) is discharged from the turbine in a radial direction as indicated schematically by the arrows 30, toward recirculation loop means comprising, for example, a divergent 51 hermetically connected to the outlet of the turbine and a lateral blowing duct 52 which then distributes the discharged gas over the entire length L of the box. The divergent 51 is hermetically extended by a lateral blowing duct 52 situated along and advantageously over the entire surface of a lateral wall 43 of the central compartment 40. Such a configuration makes it possible considerably to reduce the bulk of the lateral blowing duct 52, which may therefore be small in thickness. For preference also, the cross section of the duct 52 is rectangular. Optionally, the duct 52 is provided with internal guide walls, for better distribution of the stream across the duct, and when reintroducing it into the compartment 40 via the orifice 47.

The lateral blowing duct 52 opens onto an inlet orifice 47 of the central compartment, which preferably extends over the entire length of the compartment 40. The hot air is thus reintroduced into the compartment 40 underneath the mat of fibers 12 and made to pass through it again under the effect of the suction created on its opposite face by the turbine 50.

FIG. 4 is a side view, in section through its middle, of the box of FIG. 3, in order to provide a more in-depth illustration of how it works. FIG. 4 also depicts other elements, and in particular:
the external insulating jacket 49,
an external metal enclosed space 55,
a heating means 53, positioned either inside the compartment 40 or downstream of the turbine 50, in the direction of circulation of the hot gases as described hereinabove,
the endless and gas-permeable belts of the two conveyors 18A, 18B that transport and size the mat 12
the drive motor 57 for the radial turbine, which is placed outside the enclosed space and above the external insulating jacket 49, as well as the drive shaft 56 that connects said motor to the turbine.

For a better understanding of how the invention works, an external insulating jacket 49 has been depicted in FIG. 4 as surrounding all of the boxes 20 of the drying oven. Usually, the external insulating jacket itself surrounds a first external metal enclosed space 55 which surrounds the drying oven as a whole, this enclosed space being constructed and welded together in order to seal the installation as a whole.

Within the compartment 40, heating means 53 are also provided according to the invention (these being depicted in FIGS. 4 and 4bis only), to allow the hot gases to be kept at the temperature required to ensure the curing of the binder under the optimal conditions required within each box. Such heating means may for example be positioned in the central compartment 40, between the mat of fibers 12 and the hot-gas outlet orifice 48. It may in particular and for preference be a radiant tube. According to another possible embodiment, the heating means may be positioned at the outlet of the radial turbine 50, in particular in the lateral blowing duct 52. Once again, this means may advantageously be a radiant tube or a burner.

FIG. 4bis this time is a schematic view from above of the box 20 already depicted in FIGS. 3 and 4, surrounded by the metal enclosed space 55 and the external insulating jacket 49 of the drying oven. The mat of fibers 12, conveyed by the conveyors 18A and 18B, is introduced into the central compartment 40 via an inlet opening or lock 58 and reemerges therefrom having passed through it, via an outlet opening or lock 59.

For preference, according to such a configuration comprising just one single turbine 50, this turbine is situated in a central position on the box 40. The turbine 50 of course comprises a housing surrounding it in an airtight manner. It has a shape of any suitable type so that the turbine produces a suction effect at the inlet of the housing and a blowing effect at the outlet of the housing.

The in-built heating and extraction device, preferably included within each box of a drying oven according to the invention, comprises, in addition to the radial turbine 50, recirculation means for recirculating the hot gases at the outlet of said turbine so that these can be reinjected onto the opposite face of the mat of mineral wool, with reference to the outlet orifice 48 for said gases. The recirculation means illustrated in FIGS. 3 to 5 advantageously comprise a divergent 51 and a lateral blowing duct 52, but any other known means may of course be envisioned without departing from the scope of the invention, that allows said gases to be conveyed from the outlet of the turbine 50 to the gas inlet orifice 47 of the compartment 40.

According to this embodiment, the in-built heating and extraction device thus draws the hot gases in from one side of the mat and reinjects them onto the opposite side of the compartment, so as to produce an upward vertical stream of hot gases through the mat.

The figures also depict a configuration whereby the turbine 50 is situated above the compartment 40, which means to say in the upper part of the box. It is obvious that, according to the invention, the turbine may equally be positioned this time underneath the compartment 40, which means to say in the bottom part of the box. In such a case, the outlet orifice 48 for the stream of hot gas 30 is then made in the lower wall 46 of the central compartment 40 and the turbine is mounted on the lower wall 46 of the central compartment, the inlet of the turbine being arranged facing the hot-gas outlet orifice 48. With such a configuration, the recirculation means described above this time allows said gases to be conveyed from the outlet of the turbine 50 to the gas inlet orifice 47 of the compartment 40, said gas inlet orifice 47 then being made in the upper part of the compartment 40 so as to allow said gases to recirculate and to pass through the mat 12 in a downward stream. In this alternative form, the turbine 50 is then arranged underneath the compartment 40 and the extraction of the hot gases is performed on the underside of the box, whereas the hot gases are reintroduced into the compartment on an upper side of the box. The heating and extraction device as a whole is thus identical to the one described earlier but arranged the other way up.

As described earlier, the heating and extraction device according to the invention thus forms an in-built hot-gas recirculation circuit allowing the crosslinking of the binder, thereby limiting heat losses and energy consumption.

As illustrated in FIG. 2, the first four boxes are, for example, configured to produce an upward stream of hot gases whereas the next three boxes are configured to produce a downward stream of hot gases, according to the principles described hereinabove. As an alternative, an alternation of upward/downward streams in the various boxes is also possible according to the invention.

According to the invention, as a general rule, each heating device 53 is independent and comprises means for controlling the temperature and flow rate of the hot gases. The heating device is, for example, configured to produce a stream of hot gas of which the temperature, as it passes through the mat of fibers 12, is between 200° C. and 250° C., the temperature of course being dependent on the type of binder used. Other boxes may be set to different temperatures. As far as the flow rate is concerned, the device is, for example, configured so that the turbine produces a gas flow rate of the order of 1000 to 60 000 m³/h.

FIGS. 5 and 5bis illustrate another embodiment of the invention in which the box comprises two heating and recirculation devices, including two distinct radial turbines 50A and 50B, the two turbines being arranged relative to one another with central symmetry on the central compartment of the box. The box thus comprises two hot-gas circuits, the first circuit occupying a first half of the length of the main chamber whereas the second circuit occupies the second half.

With such a configuration, each turbine 50A, 50B is connected to separate recirculation means namely respectively:
a first blowing duct 51A in fluidic communication with the first radial turbine 50A, said blowing duct 51A being situated on a first lateral wall 43 of the compartment and opening onto s first inlet orifice 47A made on said first lateral wall 43,
a second blowing duct 51B in fluidic communication with the second radial turbine 50B, said blowing duct 51A being situated on the opposite lateral wall 44 of the compartment 40 and opening onto a second inlet orifice 47b made in said opposite lateral wall 44.

As depicted in FIGS. 5 and 5bis, the first inlet orifice 47A, onto which the first lateral blowing duct 52A opens has, for example, a length substantially equal to half that of the central compartment 40, and the second inlet orifice 47B, onto which the second lateral blowing duct 52B opens, has a length substantially equal to half that of the central compartment 40.

For preference, the two orifices together cover substantially the entirety of the length of the central compartment 40. According to another advantageous configuration depicted in FIGS. 5 and 5bis, the two orifices 47A, 47B are in offset positions on the opposite lateral walls 42, 44.

1. A drying oven for crosslinking a continuous mat of mineral or plant fibers, comprising:
a plurality of heating boxes through which said mat of fibers successively passes, said boxes each comprising a central compartment delimited by lateral walls, an upper wall, and a lower wall, said compartment comprising inlet and outlet orifices for a stream of hot gas, the inlet and outlet orifices being situated on each side of the mat of fibers, so that after the stream of hot gas has passed through the mat the binder is progressively raised to a temperature above its curing temperature;
at least one conveyor for conveying the mat through the boxes, said conveyor being permeable to the stream of hot gas passing through said mat; and
an external insulating jacket surrounding said plurality of boxes,
wherein at least one of said boxes further comprises, between the external insulating jacket and said central compartment, an in-built hot-gas heating and recirculation device comprising:
at least one radial turbine mounted horizontally on the upper wall or the lower wall of the central compartment, an axis of rotation of which is arranged vertically, said turbine drawing the hot gas along said axis through a gas outlet orifice of the central compartment after the hot gas has passed through the mat, and discharging the hot gas radially toward recirculation means,
the recirculation means recirculating the hot gas leaving the radial turbine to a gas inlet orifice of the compartment, said recirculation means being arranged at least in part on at least one of the lateral walls of the compartment, and
at least one heating means for heating the gas circulating in said box.

2. The drying oven as claimed in claim 1, in which the outlet orifice or orifices for the stream of hot gas are made in the upper wall of the central compartment and in which the turbine or turbines are mounted on the upper wall of the central compartment, the inlet of a turbine being positioned facing a hot-gas outlet orifice.

3. The drying oven as claimed in claim 1, in which the outlet orifice or orifices for the stream of hot gas are made in the lower wall of the central compartment and in which the turbine or turbines are mounted on the lower wall of the central compartment, the inlet of a turbine being arranged facing a hot-gas outlet orifice.

4. The drying oven as claimed in claim 1, in which the heating means is inbuilt into or opens into said box.

5. The drying oven as claimed in claim 1, in which the gas heating means is positioned in the central compartment between the mat of fibers and the hot-gas outlet orifice.

6. The drying oven as claimed in claim 1, in which the gas-heating means is positioned at the outlet of the radial turbine, said heating means opening into or being situated in said recirculation means.

7. The drying oven as claimed in claim 1, in which the recirculation means comprise a divergent in gaseous communication with the outlet of the turbine, and hermetically extended by at least one lateral blowing duct situated along a lateral wall of the central compartment, said blowing duct opening onto an inlet orifice of the central compartment.

8. The drying oven as claimed in claim 1, in which an extraction duct vertically connects a gas outlet orifice to a turbine inlet.

9. The drying oven as claimed in claim 1, in which the heating and recirculation device comprises a single radial turbine arranged at the center of the upper wall or of the lower wall of the central compartment and facing a single hot-gas outlet orifice.

10. The drying oven as claimed in claim 1, in which the heating and recirculation device comprises two radial turbines.

11. The drying oven as claimed in claim 10, in which each turbine is connected to separate recirculation means comprising:
a first blowing duct in fluidic communication with a first radial turbine, said blowing duct being situated on a first lateral wall of the compartment and opening onto a first inlet orifice made on said first lateral wall, and
a second blowing duct in fluidic communication with the second radial turbine, said blowing duct being situated on the opposite lateral wall of the compartment and opening onto a first inlet orifice made in said opposite lateral wall.

12. The drying oven as claimed in claim 11, in which:
the first inlet orifice, onto which the first blowing duct opens, has a length substantially equal to half that of the central compartment,
the second inlet orifice, onto which the second blowing duct opens, has a length substantially equal to half that of the central compartment,
the two orifices together cover substantially all of the length of the central compartment, and
the two orifices are in offset positions on the opposite lateral walls.

13. The drying oven as claimed in claim 1, in which a hot-gas bypass opening is formed between the central compartment and at least one blowing duct.

14. A box for a drying oven for crosslinking a continuous mat of mineral or plant fibers, comprising:
a central compartment delimited by lateral walls, an upper wall, and a lower wall, inlet and outlet locks sized for the passage of a mat of fibers, comprising, in the central compartment, inlet and outlet orifices for a stream of hot gas, the inlet and outlet orifices being situated on each side of the mat of fibers, and
in-built hot-gas heating and recirculation device comprising:
at least one radial turbine mounted horizontally on the upper wall or the lower wall of the central compartment, the axis of rotation of which is arranged vertically, said turbine drawing the hot gas along said axis through a gas outlet orifice of the central compartment and discharging the hot gas radially toward recirculation means,
recirculation means recirculating the gas leaving the radial turbine to the gas inlet orifice of the compartment, said recirculation means being arranged at least in part on at least one of the lateral walls of the compartment, and
at least one heating means for heating the air circulating in said box.

15. A production line for the manufacture of a continuous mat of mineral and/or plant fibers, comprising:
at least one fiberizing unit for producing a continuous mat of mineral and/or plant fibers,
a conveyor for conveying the mat, and
the drying oven as claimed in claim 1.

16. The drying oven as claimed in claim 1, in which an extraction duct is convergent.

17. The drying oven as claimed in claim 5, in which the gas heating means is a radiant tube.

18. The drying oven as claimed in claim 10, in which the two radial turbines are arranged with central symmetry with respect to the upper wall or the lower wall of the central compartment.
